(19) United States
(12) Patent Application Publication
(10) Pub. No.: US 2011/0316486 A1
(43) Pub. Date: Dec. 29, 2011

(54) Charge Control System

(75) Inventors: Ryo INABA, Hitachi-shi (JP); Naoyuki Tashiro, Atsugi-shi (JP)

(73) Assignee: Hitachi, Ltd., Tokyo (JP)

(21) Appl. No.: 13/170,834

(22) Filed: Jun. 28, 2011

(30) Foreign Application Priority Data
Jun. 29, 2010 (JP) 2010-147415

(51) Int. Cl. H02J 7/00

(52) U.S. Cl. 320/150

(57) ABSTRACT

The charge control system includes at least a battery temperature control device, a cooling device, a heating device, and an integrated control device. The battery control device detects SOC of a battery. Based on the detected SOC, the integrated control device switches between a first charging mode in which the battery is charged at a substantially constant current and a second charging mode in which the battery is charged at a substantially constant voltage. In the second charging mode, the battery temperature control device performs rapid cooling control to control the cooling device such that it has a cooling capacity in the second charging mode higher than a cooling capacity in the first charging mode. Thus, the battery temperature is appropriately controlled to increase a cruising distance even when the electric vehicle is run immediately after completion of charging.

### INCORPORATION BY REFERENCE

The disclosure of the following priority application is herein incorporated by reference: Japanese Patent Application No. 2010-147415 filed Jun. 29, 2010.

### BACKGROUND OF THE INVENTION

1. Field of the Invention

The present invention relates to a charge control system for an electric vehicle that is mounted on the electric vehicle and controls a charge current from an external power source to an in-vehicle battery on the electric vehicle.

2. Description of Related Art

Generally, an electric motor is used as a drive source for electric vehicles to which power can be supplied from an external power source and the electric vehicles are each equipped with an in-vehicle battery for driving the electric motor. The in-vehicle battery generates heat upon charge and discharge so that the temperature of the battery or battery temperature increases. However, depending on the outside air temperature and operation conditions, it may happen that the amount of heat radiation is greater than the amount of heat generation, so that the battery temperature can decrease.

Generally, batteries are deteriorated when charge and/or discharge is performed at very low temperatures or high temperatures. Accordingly, a range of battery temperature appropriate for charge and/or discharge (i.e., charge-discharge allowing battery temperature range) is predetermined. Upon charge and discharge of an in-vehicle battery, it is necessary to control the temperature of the battery so as to be within the set charge-discharge allowing battery temperature range. As such a method of controlling the battery temperature, there has been known a method of controlling the battery temperature by using a cooler or a heater (cf., Japanese Patent Laid-open Publication No. 2005-117727 and Japanese Patent Laid-open Publication No. 2007-330008). Japanese Patent Laid-open Publication No. 2005-117727 discloses a technique in which a charge current and outputs of the cooler and the heater are controlled so that a battery temperature at which the deterioration of the battery upon discharge is minimal (hereafter, “ideal discharge battery temperature”) can be obtained immediately after completion of charge. Japanese Patent Laid-open Publication No. 2007-330008 discloses a technique in which a target battery temperature is set depending on a State of Charge (SOC), which indicates a ratio of a charged capacity to a rated capacity of the battery upon charging, and the outputs of the cooler and the heater are controlled, so that the battery temperature can reach the target battery temperature.

### SUMMARY OF THE INVENTION

According to the technology disclosed in Japanese Patent Laid-open Publication No. 2005-117727, since the battery is set to an ideal discharge battery temperature upon completion of charge, discharge from the battery can be started without limitation immediately after completion of charge. However, due to heat generation caused by the discharge current accompanying the start of running of the electric vehicle, it may happen that the cooler is operated immediately after the start of running. As a result, energy that can be used for driving the electric motor is reduced and this shortens a cruising distance of the electric vehicle.

On the other hand, according to the technology disclosed in Japanese Patent Laid-open Publication No. 2007-330008, a temperature at which the deterioration of the battery is minimal is set depending on the SOC and the cooler and the heater are controlled so that the set temperature can be obtained. However, the battery temperature is not necessarily low after completion of charging, and when the electric vehicle starts running immediately after charging, it is conceivable that cooling by using battery power becomes necessary at once. In such a case, operation of the cooler reduces energy that can be used for driving the electric motor and hence there arises a problem that the cruising distance of the electric vehicle is shortened.

The present invention is made under the circumstances and it is an object of the present invention to appropriately control the battery temperature when an electric vehicle is operated to run immediately after the completion of charging the battery to increase the cruising distance of the electric vehicle.

According to a first aspect, the present invention provides a charge control system for use in an electric vehicle that is mounted thereon for controlling charging of an in-vehicle battery by an external power source, the system comprising: an SOC detection unit that detects an SOC of the in-vehicle battery; a battery temperature detection unit that detects a battery temperature of the in-vehicle battery; a battery temperature control unit that controls a cooling device that cools the in-vehicle battery with a predetermined cooling capacity and a heating device that heats the in-vehicle battery with a predetermined heating capacity based on the battery temperature detected by the battery temperature detection unit; a charge control unit that controls a charge current and a charge voltage upon charging the in-vehicle battery by the external power source; wherein the charge control unit switches between a first charging mode in which the charge current is controlled so as to reach a constant value and a second charging mode in which the charge voltage is controlled so as to reach a constant value based on the SOC detected by the SOC detection unit, and the battery temperature control unit controls at least one of the cooling device and the heating device such that the cooling capacity and/or the heating capacity in the second charging mode are higher than the cooling capacity and/or the heating capacity in the first charging mode.

According to a second aspect, the charge control system according to the first aspect may be configured such that in the second charging mode, the battery temperature control unit controls at least one of the cooling device and the heating device such that the battery temperature is identical with a predetermined lower limit value of a charge-discharge allowing battery temperature.

According to a third aspect, the charge control system according to the first aspect may further comprise: an outside air temperature detection unit that detects a temperature of outside air; and a target battery temperature calculation unit that calculates a target battery temperature based on the temperature of the outside air detected by the outside air temperature detection unit, wherein the battery temperature control unit controls at least one of the cooling device and the heating device such that in the second charging mode, the battery temperature is identical with the target battery temperature.

According to a fourth aspect, the charge control system according to the third aspect may be configured such that the target battery temperature calculation unit calculates the target battery temperature by determining an offset temperature based on the temperature of the outside air, and adding the offset temperature to a predetermined lower limit value of a charge-discharge allowing battery temperature.

According to a fifth aspect, the charge control system according to the fourth aspect may be configured such that the target battery temperature calculation unit determines the offset temperature between a maximum value and a minimum value of the offset temperature, taking a value obtained by subtracting the lower limit value of the charge-discharge allowing battery temperature from a predetermined upper limit value of the charge-discharge allowing battery temperature as the maximum value of the offset temperature and taking 0 as the minimum value of the offset temperature.

According to a sixth aspect, the charge control system according to the fifth aspect may be configured such that the upper limit value and the lower limit value of the charge-discharge allowing battery temperature are determined in advance taking into consideration deterioration of the in-vehicle battery.

According to a seventh aspect, the charge control system according to the fourth aspect may be configured such that the target battery temperature calculation unit decreases the offset temperature as the outside air temperature increases.

According to an eighth aspect, the charge control system according to the third aspect may further comprise: a forecasted load estimation unit that estimates a forecasted load of the in-vehicle battery; wherein the target battery temperature calculation unit calculates the target battery temperature by determining an offset temperature based on the forecasted load and the outside air temperature, and adding the calculated offset temperature to a predetermined lower limit value of a charge-discharge allowing battery temperature.

According to a ninth aspect, the charge control system according to the eighth aspect may be configured such that the target battery temperature calculation unit determines the offset temperature between a maximum value and a minimum value of the offset temperature, taking a value obtained by subtracting the lower limit value of the charge-discharge allowing battery temperature from a predetermined upper limit value of the charge-discharge allowing battery temperature as the maximum value of the offset temperature and taking 0 as the minimum value of the offset temperature.

According to a tenth aspect, the charge control system according to the ninth aspect may be configured such that the upper limit value and the lower limit value of the charge-discharge allowing battery temperature are determined taking into consideration deterioration of the in-vehicle battery.

According to an eleventh aspect, the charge control system according to the eighth aspect may be configured such that the target battery temperature calculation unit decreases the offset temperature as the outside air temperature increases or the forecasted load increases.

According to a twelfth aspect, the charge control system according to the third aspect may further comprise: a forecasted load estimation unit that estimates a forecasted load of the in-vehicle battery, wherein the target battery temperature calculation unit calculates the target battery temperature by obtaining a battery temperature variation based on the forecasted load and the outside air temperature, determining an offset temperature based on the obtained battery temperature variation, and adding the obtained offset temperature to a predetermined lower limit value of a charge-discharge allowing temperature.

According to a thirteenth aspect, the charge control system according to the twelfth aspect may be configured such that the target battery temperature calculation unit determines the offset temperature by assuming an intermediate value between a predetermined upper limit value of the charge-discharge allowing battery temperature and the lower limit value of the charge-discharge allowing battery temperature to be the offset temperature when the battery temperature variation is 0 and adjusting the offset temperature so as to become smaller than the intermediate value when the battery temperature variation takes a negative value and larger than the intermediate temperature when the battery temperature variation takes a negative value.

According to a fourteenth aspect, the charge control system according to the thirteenth aspect may be configured such that the upper limit value and the lower limit value of the charge-discharge allowing battery temperature are determined in advance taking into consideration deterioration of the in-vehicle battery.

According to a fifteenth aspect, the charge control system according to the twelfth aspect may be configured such that the target battery temperature calculation unit increases the battery temperature variation as the outside air temperature increases or the forecasted load increases.

According to a sixteenth aspect, the charge control system according to the first aspect may further comprise: an immediately-after-completion-of-charging running determination unit that determines whether or not the electric vehicle starts running immediately after completion of charging the in-vehicle battery, wherein the battery temperature control unit controls the cooling device and/or the heating device to cool and/or heat the in-vehicle battery while the in-vehicle is being charged when it is determined by the immediately-after-completion-of-charging running determination unit that the electric vehicle starts running immediately after completion of charging of the in-vehicle battery, whereas the battery temperature control unit controls the cooling device and the heating device not to cool and heat, respectively, the in-vehicle battery while the in-vehicle battery is being charged when it is determined by the immediately-after-completion-of-charging running determination unit that the electric vehicle does not start running immediately after completion of charging of the in-vehicle battery.

According to a seventeenth aspect, the charge control system according to the sixteenth aspect may further comprise: an information obtaining unit that obtains at least one of instruction information from an operator, position information on the position of the electric vehicle, and information on an installation location of the external power source, wherein the immediately-after-completion-of-charging running determination unit determines whether or not the electric vehicle starts running immediately after completion of charging the in-vehicle battery based on the information obtained by the information obtaining unit.

According to the present invention, the cruising distance of an electric vehicle can be increased by appropriately controlling the temperature of the battery when the electric vehicle is run immediately after completion of charging.

### BRIEF DESCRIPTION OF THE DRAWINGS

FIG. 1 presents a schematic construction diagram of an electric vehicle on which a charge control system according to the present invention is mounted;

FIG. 2 presents a construction diagram of a charge control system according to the first embodiment of the present invention;

FIG. 3 presents a control flowchart of the charge control system according to the first embodiment of the present invention;

FIG. 4 presents a flowchart illustrating processing in a battery temperature control charging mode of the charge control system according to the first embodiment of the present invention;

FIG. 5 presents a flowchart illustrating processing in a first charging mode of the charge control system according to the first embodiment of the present invention;

FIG. 6 presents a flowchart illustrating processing in battery temperature control of the charge control system according to the first embodiment of the present invention;

FIG. 7 presents a flowchart illustrating processing in a second charging mode of the charge control system according to the first embodiment of the present invention;

FIG. 8 presents a graph illustrating an example of variations of SOC, charge current, charge voltage and battery temperature in the charge control system according to the first embodiment of the present invention;

FIG. 9 presents a flowchart illustrating processing in a second charging mode of a charge control system according to a second embodiment of the present invention;

FIG. 10 presents a graph illustrating an example of the relationship between outside air temperature and offset temperature in the charge control system according to the second embodiment of the present invention;

FIG. 11 presents a graph illustrating another example of the relationship between outside air temperature and offset temperature in the charge control system according to the second embodiment of the present invention;

FIG. 12 presents a graph illustrating an example of the variation in a battery temperature in the charge control system according to the second embodiment of the present invention;

FIG. 13 presents a construction diagram of a charge control system according to a third embodiment of the present invention;

FIG. 14 presents a graph illustrating an example of the relationship among outside air temperature, forecasted load, and offset temperature in the charge control system according to the third embodiment of the present invention;

FIG. 15 presents a graph illustrating an example of the relationship among outside air temperature, forecasted load, and battery temperature change rate in a charge control system according to a fourth embodiment of the present invention;

FIG. 16 presents a graph illustrating an example of the relationship among battery temperature change rate and offset temperature in the charge control system in the fourth embodiment of the present invention;

FIG. 17 presents a control flowchart of a charge control system according to a fifth embodiment of the present invention; and

FIG. 18 presents a flowchart illustrating processing in a normal charging mode of a charge control system according to a fifth embodiment of the present invention.

### DESCRIPTION OF PREFERRED EMBODIMENTS

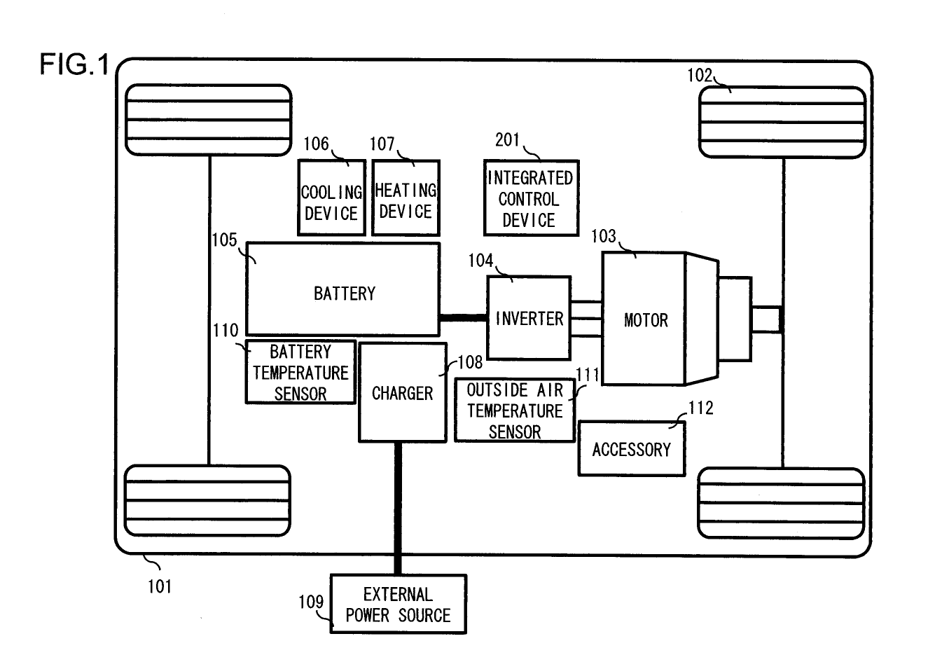

FIG. 1 presents a diagram schematically showing the construction of an electric vehicle 101 on which a charge control system according to the present invention is mounted. The electric vehicle 101 includes a motor 103 for running that outputs a driving force to driving wheels 102, an inverter 104 that controls the driving force provided by the motor 103, a battery 105 that supplies power to the motor 103 through the inverter 104, a cooling device 106 for cooling the battery 105, a heating device 107 for heating the battery 105, a charger 108 that converts power supplied from an external power source 109 and charges the battery 105, a battery temperature sensor 110 that measures the temperature of the battery 105, an outside air temperature sensor 111 that measures the temperature of outside air, an accessory 112 such as a head light or power steering, and an integrated control device 201 that controls these.

The inverter 104 is constructed as an inverter circuit having six semiconductor switching elements. By switching the semiconductor switching elements, the inverter 104 converts direct current (DC) power supplied from the battery 105 into three-phase alternating current power and then supplies the power to the three-phase coil of the motor 103.

The motor 103 is provided with a rotation sensor (not shown) for measuring the rotation number thereof. The rotation number of the motor 103 measured by the rotation sensor is output to the inverter 104 and is used for switching control of each semiconductor switching element in the inverter 104.

The battery 105 may be of any type as far as it is a rechargeable secondary cell. For example, it is conceivable to use a nickel hydride cell or lithium ion battery as the battery 105.

The cooling device 106 for cooling the battery 105 may be of any type as far as it can render variable the cooling capacity thereof. For example, an air-cooled or water-cooled type cooling device equipped with an electric fan, an air conditioner equipped with an electric heat pump, a thermoelectric conversion element such as a Peltier element, or the like may be used as the cooling device 106. Alternatively, two or more cooling devices 106 having different cooling capacities may be used by switching them. Similarly, the heating device 107 for heating the battery 105 may be of any type as far as the heating capacity can be made variable. For example, in addition to the above-mentioned air conditioner or thermoelectric conversion element, a heating wire, or a heating wire to which a fan is attached may be used in the heating device 107. Alternatively, two or more heating devices 107 having different heating capacities may be used by switching them.

The cooling device 106 and the heating device 107 are preferably those that operate by using electric power in order to make the cooling capacity and heating capacity variable depending on power consumption. However, the cooling device 106 and the heating device 107 may be those devices that operate with energy other than electric power as far as the cooling capacity and the heating capacity, respectively, can be varied.

The battery 105 is provided with the battery temperature sensor 110 for measuring the temperature of the battery 105 and the outside air temperature sensor 111 for measuring the temperature of outside air. Examples of the sensors for measuring these temperatures may include a thermocouple and a thermistor.

Next, the charge control systems according to the first to the fifth embodiments of the present invention are explained in detail embodiment by embodiment with reference to the attached drawings.

### First Embodiment

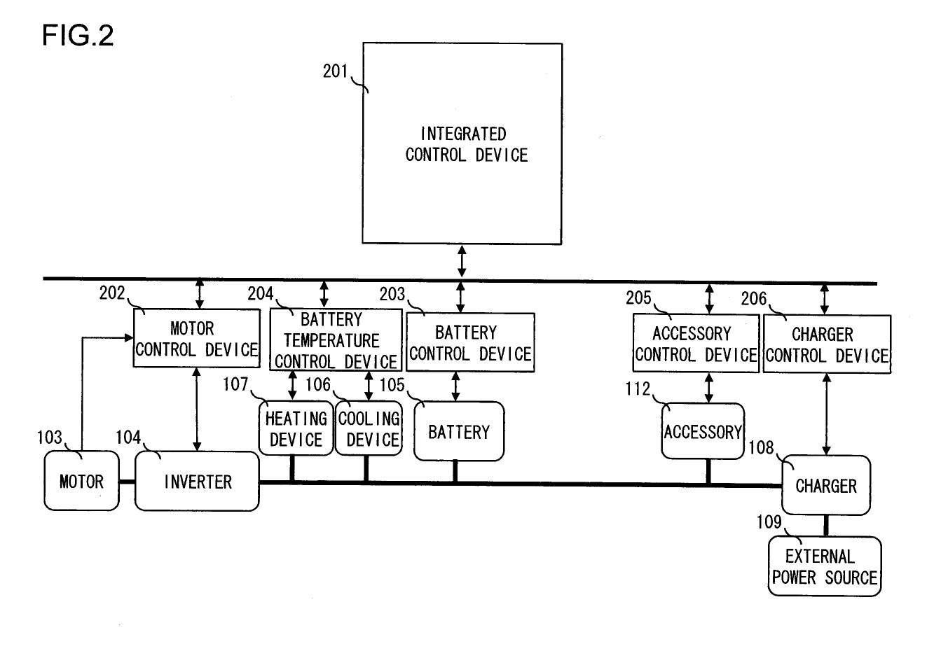

FIG. 2 presents a diagram showing the construction of the charge control system according to the first embodiment of the present invention. The charge control system includes an integrated control device 201; a motor control device 202 for controlling the inverter 104 and the motor 103; a battery control device 203 for controlling the battery 105; a battery temperature control device 204 for controlling the cooling device 106 and the heating device 107; an accessory control device 205 for controlling an accessory 112; and a charger control device 206 for controlling the charger 108. These control devices are mutually connected through a communication network, for example, CAN (Controller Area Network) provided in the electric vehicle 101.

In the charge control system shown in FIG. 2, the inverter 104, the cooling device 106, the heating device 107, the accessory 112, and the charger 108, respectively, are connected to the battery 105. As a result, the power from the battery 105 is supplied to the inverter 104, the cooling device 106, the heating device 107, and the accessory 112. The power from the external power source 109 converted by the charger 108 is supplied to the battery 105 to charge the battery 105.

The integrated control device 201 inputs or outputs predetermined information from or to each of the other control devices, if needed, thus performing control by integrating each control device.

The motor control device 202 performs calculation of a current command value for the inverter 104 or other operation based on information such as a torque command value that is output from the integrated control device 201 or the rotation number of the motor 103 measured by the rotation sensor. The inverter 104 controls switching of each semiconductor switching element based on the current command value calculated by the motor control device 202 and the voltage of the battery 105.

The battery control device 203 detects the SOC of the battery 105 by a conventional method and transmits the result of detection to the integrated control device 201.

The battery temperature control device 204 detects the temperature of the battery 105, i.e., battery temperature by using the battery temperature sensor 110 shown in FIG. 1 and detects outside air temperature by using the outside air temperature sensor 111 shown in FIG. 1. The battery temperature and the outside air temperature detected by the battery temperature control device 204 are used for controlling the cooling device 106 and the heating device 107 and is output from the battery temperature control device 204 to the integrated control device 201.

The accessory control device 205 controls the accessory 112 based on the command from the integrated control device 201.

The charger control device 206 provides a command to the charger 108 so as to convert the power supplied from the external power source 109 into desired voltage and current to thereby control charge voltage and charge current from the charger 108 to the battery 105.

The motor control device 202, the battery control device 203, the battery temperature control device 204, the accessory control device 205, and the charger control device 206 may be each integrated with the respective target to be controlled. That is, it can be constructed such that the motor control device 202 is integrated with the inverter 104; the battery control device 203 is integrated with the battery 105; the battery temperature control device 204 is integrated with the cooling device 106 or the heating device 107; the accessory control device 205 is integrated with an accessory 112; and the charger control device 206 is integrated with the charger 107. Alternatively, these may be constructed to be separate from each other.

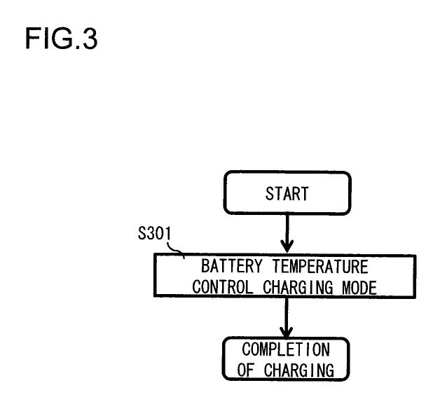

Next, operation of the charge control system according to the first embodiment of the present invention, particularly operation upon charging by using the external power source 109, is explained with reference to FIGS. 3 to 8.

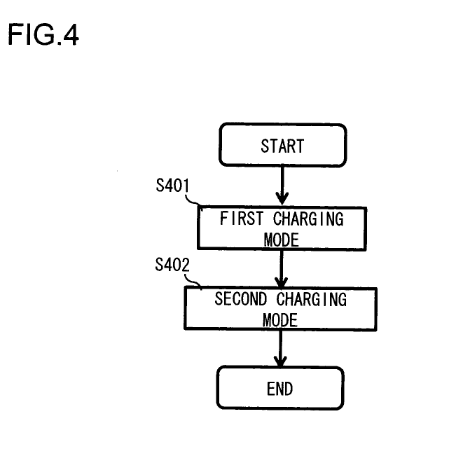

When the electric vehicle 101 is connected to the external power source 109, the process illustrated in the control flowchart shown in FIG. 3 is performed in the integrated control device 201. In step S301, the integrated control device 201 performs an operation in a battery temperature control charging mode. Here, the process illustrated in the flowchart shown in FIG. 4 is performed.

In the battery temperature control charging mode, the integrated control device 201 performs an operation in a first charging mode in step S401 and an operation in a second charging mode in step S402 in the order as shown in FIG. 4. The first charging mode in step S401 is a constant current mode in which the battery 105 is charged with a substantially constant current. On the other hand, the second charging mode in step S402 is a constant voltage mode in which the battery 105 is charged at a substantially constant voltage.

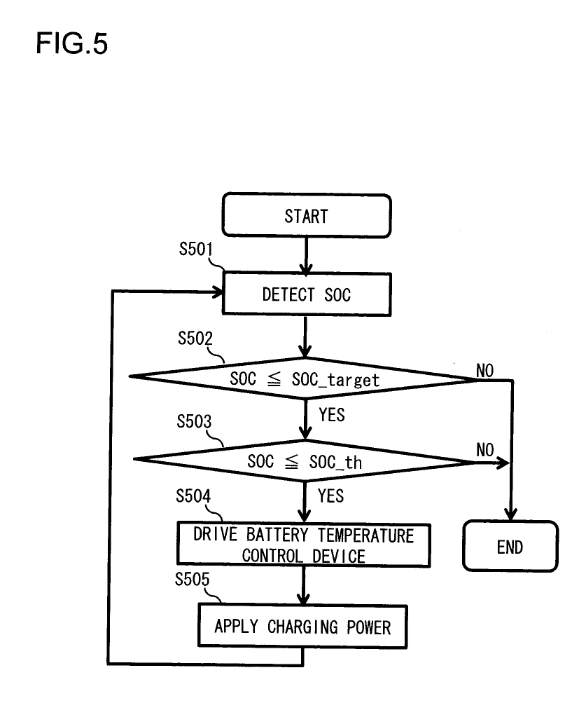

First, the processing in the first charging mode in step S401 is explained. FIG. 5 presents a flowchart illustrating the processing in the first charging mode.

In step S501, the SOC of the battery 105 is detected by the battery control device 203. Here, a command to detect the SOC is output from the integrated control device 201 to the battery control device 203. In response to this command, the SOC of the battery 105 is detected by the battery control device 203 and the result of detection is transmitted to the integrated control device 201.

In step S502, the SOC detected in step S501 is compared with a preset target value of SOC (SOC_target) by the integrated control device 201. As a result, when the SOC is not greater than the SOC_target, the process proceeds to step S503. On the other hand, when the SOC is greater than the SOC_target, the operation in the first charging mode shown in FIG. 5 is completed and the mode is changed to the second charging mode. The value of SOC_target may be, for example, a constant value that is set upon shipment of the charge control system according to this embodiment. Alternatively, the operator of the charge control system may set any value before charging is started or during charging.

In step S503, the SOC detected in step S501 is compared with a preset threshold of SOC (SOC_th) by the integrated control device 201. As a result, when the SOC is not greater than the SOC_th, the process proceeds to step S504. On the other hand, when the SOC is greater than the SOC_th, the operation in the first charging mode shown in FIG. 5 is ended, and the charging mode is changed to the second charging mode. It is preferred that the value of SOC_th is set depending on the characteristics of the battery 105. The value of SOC_th may be either larger or smaller than the above-mentioned SOC_target. Alternatively, the SOC_target and the SOC_th may be made the same.

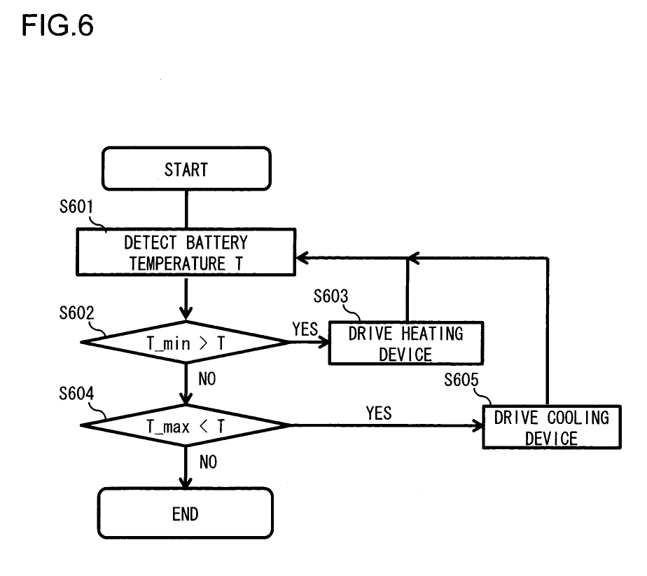

In step S504, battery temperature control is performed by driving the battery temperature control device 204. Here, a command for driving the battery temperature control device 204 is output from the integrated control device 201 to the battery temperature control device 204. In response to the command, the battery temperature control device 204 is driven and control of the temperature of the battery 105 is performed by the battery temperature control device 204 by using the cooling device 106 and the heating device 107. The content of the battery temperature control in step S504 is explained in detail later with reference to the flowchart shown in FIG. 6.

In step S505, charging power is applied to the battery 105 by the charger 108. Here, a command for charging the battery 105 in a constant current mode is output from the integrated control device 201 to the charger control device 206. In response to this command, the charger control device 206 controls the charger 108 such that the charge current that flows in the battery 105 reaches a predetermined maximum charge current I_max to charge the battery 105. It is preferred that the maximum charge current I_max is determined based on the characteristics of the battery 105.

After the processing in step S505 is performed, the process returns back to step S501 to detect again the SOC of the battery 105 by the battery control device 203. By performing the processing as explained above, charging in the first charging mode of the battery 105 is performed until the condition SOC>SOC_target or SOC>SOC_th is satisfied.

Next, in step S504, the battery temperature control performed by the battery temperature control device 204 is explained. FIG. 6 presents a flowchart illustrating the processing in battery temperature control.

In step S601, the battery temperature control device 204 detects a battery temperature T, i.e., a temperature of the battery 105. Here, the battery temperature T is detected by using the battery temperature sensor 110 shown in FIG. 1.

In step S602, the battery temperature control device 204 compares the battery temperature T detected in step S601 with a preset lower limit value T_min of charge-discharge allowing battery temperature. As a result, when the battery temperature T is lower than T_min, the process proceeds to step S603, in which step the heating device 107 is driven to perform normal heating. With this, the battery 105 is heated by the heating device 107 to increase the battery temperature T. After the processing in step S603 is performed, the process returns to step S601 and again, the battery temperature T is detected. In this manner, the battery 105 is heated by using the heating device 107 until the battery temperature T becomes not lower than T_min. On the other hand, in step S602, the process proceeds to step S604 when the battery temperature is equal to or higher than Tₘᵢₙ.

In step S604, the battery temperature control device 204 compares the battery temperature T detected in step S601 with a preset upper limit value T_max of the charge-discharge allowing battery temperature. As a result, when the battery temperature T is higher than T_max, the process proceeds to step S605, in which the cooling device 106 is driven to perform normal cooling. With this, the battery 105 is cooled by the cooling device 106 so that the battery temperature T decreases. After the processing in step S605 is performed, the process returns to step S601 and again, the battery temperature T is detected. In this manner, the battery 105 is cooled by using the cooling device 106 until the battery temperature T becomes not higher than T_max. On the other hand, in step S604, the battery temperature control illustrated in FIG. 6 is ended when the battery temperature T is equal to or greater than T_max.

It is preferred that the lower limit value T_min and the upper limit value T_max of the charge-discharge allowing battery temperature explained above are determined based on the characteristics of the battery 105. For example, the lower limit value T_min and the upper limit value T_max of the charge-discharge allowing battery temperature that allows maintenance of necessary charge-discharge capacities may be set in advance by the manufacturer of the battery 105 or other person taking into consideration the deterioration of the battery 105 and these values may be used in the battery temperature control device 204.

The battery temperature control as explained above is performed by the battery temperature control device 204 in response to the command from the integrated control device 201. As a result, the cooling device 106 and the heating device 107 are controlled by the battery temperature control device 204 such that the battery temperature T indicating the temperature of the battery 105 satisfies the relation T_min≦T≦T_max.

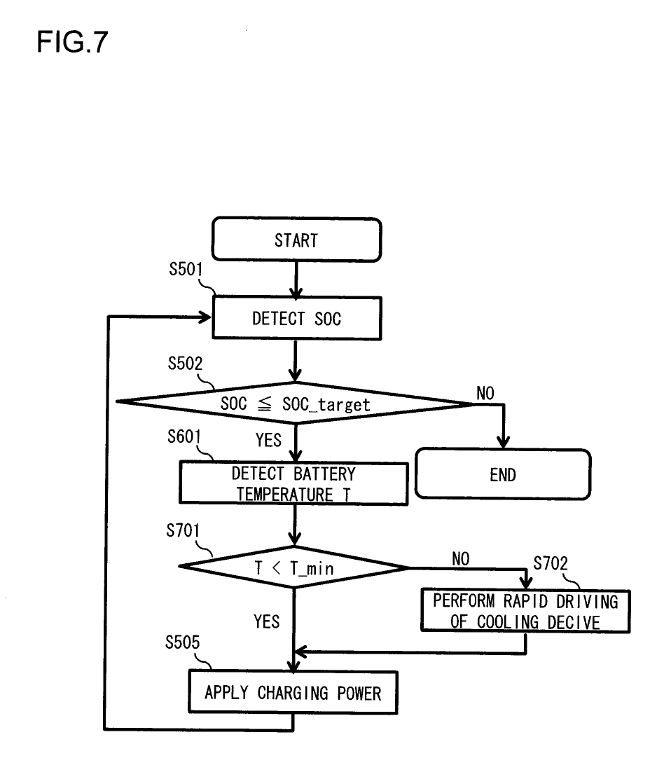

Next, the processing in a second charging mode in step S402 shown in FIG. 4 is explained. FIG. 7 presents a flowchart illustrating the process in a second charging mode. Note that in the flowchart shown in FIG. 7, the processing steps having the same content as in FIGS. 5 and 6 are given the same step numbers.

In steps S501 and S502, processing similar to that explained in FIG. 5 is performed by the battery control device 203 and the integrated control device 201. That is, the SOC of the battery 105 is detected by the battery control device 203 and the detected SOC is compared with SOC_target by the integrated control device 201. As a result, when the SOC is equal to or lower than SOC_target, the process proceeds to step S601. On the other hand, when the SOC is larger than SOC_target, the operation in the second charging mode illustrated in FIG. 7 is ended to complete charging of the battery 105.

In step S601, the battery temperature T is detected by the battery temperature control device 204. Here, a command to detect the battery temperature T is output from the integrated control device 201 to the battery temperature control device 204. In response to this command, the battery temperature control device 204 detects the battery temperature T similarly to what has been explained with reference to FIG. 6.

In step S701, the battery temperature T detected in step S601 is compared with the above-mentioned lower limit value T_min of the charge-discharge allowing battery temperature by the battery temperature control device 204. As a result, when the battery temperature T is lower than T_min, the process proceeds to step S505. On the other hand, when the battery temperature T is equal to or greater than T_min, the process proceeds to step S702.

In step S702, the cooling device 106 is driven by the battery temperature control device 204 to perform rapid cooling control. On this occasion, the output of the cooling device 106 is increased to become higher than that upon normal cooling to enable the cooling device 106 to exhibit a higher cooling capacity than that of normal cooling in step S605 illustrated in FIG. 6. For example, when the cooling capacity of the cooling device 106 can be varied depending on power consumption as explained earlier, the cooling device 106 is operated such that the power consumption is higher than the power consumption in the case of normal cooling. In this manner, the cooling device 106 is controlled so that the battery temperature T rapidly reaches T_min. When rapid cooling control is performed in step S702, the process proceeds to step S505.

Upon the rapid cooling control, the cooling device 106 may be operated at a constant output such as preset maximum output or the like. Alternatively, it may be constructed such that the larger a difference between the battery temperature T and T_min is, the more the output is increased to allow a higher cooling capacity to be exhibited. As far as the cooling capacity is higher than that of normal cooling, the cooling device 106 may be driven in any form.

In step S505, charging power is applied to the battery 105 by the charger 108. Here, a command to perform charging is output from the integrated control device 201 to the charger control device 206. In contrast to the case illustrated in FIG. 5, charging in a constant voltage mode is commanded to the charger control device 206. In response to this command, the charger control device 206 controls the charger 108 such that the charging voltage applied to the battery 105 becomes a predetermined charging voltage V to charge the battery 105. It is preferred that the charging voltage V is determined based on the characteristics of the battery 105.

After step S505 is performed, the process returns to step S501 and again, SOC of the battery 105 is detected by the battery control device 203. By performing the process as explained above, the battery 105 is rapidly cooled by the cooling device 106 such that the battery temperature T becomes Tₘᵢₙ until the condition SOC>SOC_target is satisfied, to perform charge of the battery 105 in the second charging mode.

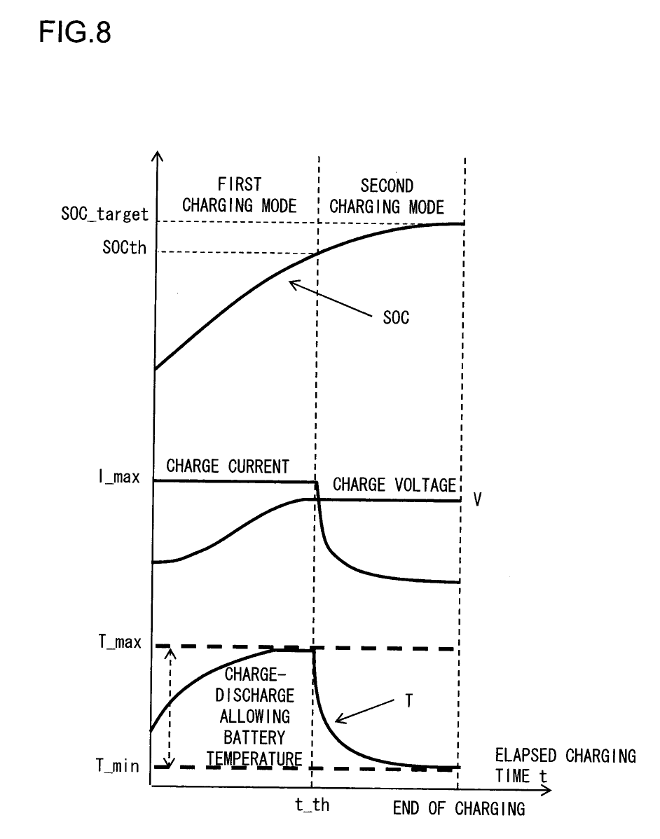

An example of the variation in SOC, charge current, charge voltage, and battery temperature when the battery 105 is charged by using the charge control system based on the respective control flowcharts illustrated in FIGS. 3 to 7 as explained above is shown in the graph in FIG. 8.

An upper diagram in FIG. 8 shows how SOC increases with elapsed charging time t. Here, an example in case SOC_th<SOC_target is shown. Assuming that an elapsed charging time when SOC=SOC_th is t_th, the battery 105 is charged in the first changing mode when t<t_th, or in the second charging mode when t≧t_th. When SOC≧SOC_target, charging of the battery 105 is ended.

The middle diagram in FIG. 8 shows how the charge current and the charge voltage vary. As shown in this diagram, the charge current does not vary in the first charging mode and assumes a substantially constant value (I_max). In the second charging mode, the charge voltage does not vary and assumes a substantially constant value (V).

The lower diagram in FIG. 8 shows how the battery temperature T varies. As shown in this diagram, the battery temperature T gradually increases in the first charging mode. During this time, the heating device 107 and the cooling device 106 are controlled so that the condition T_min<T<T_max is satisfied by the above-mentioned battery temperature control performed by the battery temperature control device 204. On the other hand, the battery temperature T rapidly decreases in the second charging mode. During this time, the cooling device 106 is controlled such that T=T_min by the above-mentioned rapid cooling control performed by the battery temperature control device 204, so that the battery 105 is positively cooled.

According to the first embodiment explained above, the advantageous effects of the invention as mentioned (1) and (2) below can be obtained.

(1) The SOC of the battery 105 is detected by the battery control device 203 (step S501 in FIG. 5), and the first charging mode and the second charging mode are switched therebetween by the integrated control device 201 based on the detected SOC (step S401, S402 in FIG. 4). On this occasion, rapid cooling control is performed by the battery temperature control device 204 in the second charging mode and the cooling device 106 is controlled such that the cooling capacity of the cooling device 106 in the second charging mode is higher than the cooling capacity of the cooling device 106 in the first charging mode (step S702 in FIG. 7). By so doing, when the charging is performed in the second charging mode, the battery temperature T can be made closer to the target temperature rapidly. As a result, the cruising distance of the electric vehicle 101 can be increased by appropriately controlling the temperature of the battery 105 when the electric vehicle 101 is run immediately after completion of the charging.

(2) In the second charging mode, the battery temperature control device 204 compares the battery temperature T with a predetermined lower limit value T_min of the charge-discharge allowing battery temperature (step S701 in FIG. 7), and performs the processing in step S702 based on the result of comparison. With this, the cooling device 106 is controlled such that the battery temperature T becomes identical with the lower limit value T_min of the charge-discharge allowing battery temperature. With this construction, even if the battery temperature increases when the electric vehicle 101 is run after completion of charging, it is possible to decrease use of the cooling device 106 as much as possible. As a result, power consumption by the cooling device 106 is suppressed so that the cruising distance of the electric vehicle 101 can be further increased.

According to the first embodiment explained above, when T<T_min, the cooling device 106 is not driven whereas when T≧T_min, the cooling device 106 is driven to perform rapid cooling control to rapidly cool the battery 105 as explained in step S701 and step S702. However, in order to prevent overcooling from occurring, the cooling device 106 may be driven when T≧T_min+alpha (alpha is any value larger than 0) to perform rapid cooling control.

According to the first embodiment explained above, there has been described an example in which neither the cooling device 106 nor the heating device 107 is driven in case of T<T_min. However, the heating device 107 may be driven in case of T<T_min. On this occasion, the normal heating similar to that in step S603 illustrated in FIG. 6 may be performed by the heating device 107. Alternatively, in order to exhibit a heating capacity that is higher than the heating capacity upon normal heating, a rapid heating control in which the heating device 107 is operated with increasing its output to a level higher than that in normal heating may be performed by the heating device 107. By so doing, the battery temperature can be made identical with the lower limit value T_min of the charge-discharge allowing battery temperature. In this case, it may be so constructed that the heating device 107 is driven when T<T_min−beta (where beta is any value larger than 0) in order to prevent overheating of the battery 105.

### Second Embodiment

Next, the charge control system according to a second embodiment of the present invention is explained. The present embodiment is different from the first embodiment in that in the second charging mode in step S402 illustrated in FIG. 4, control is performed such that the battery temperature T is not set at the lower limit value Tₘᵢₙ of the charge-discharge allowing battery temperature but at a target battery temperature T_target that is set taking into consideration an outside air temperature T_out. The target battery temperature T_target is obtained by adding an offset temperature delta_T determined depending on the outside air temperature T_out to T_min.

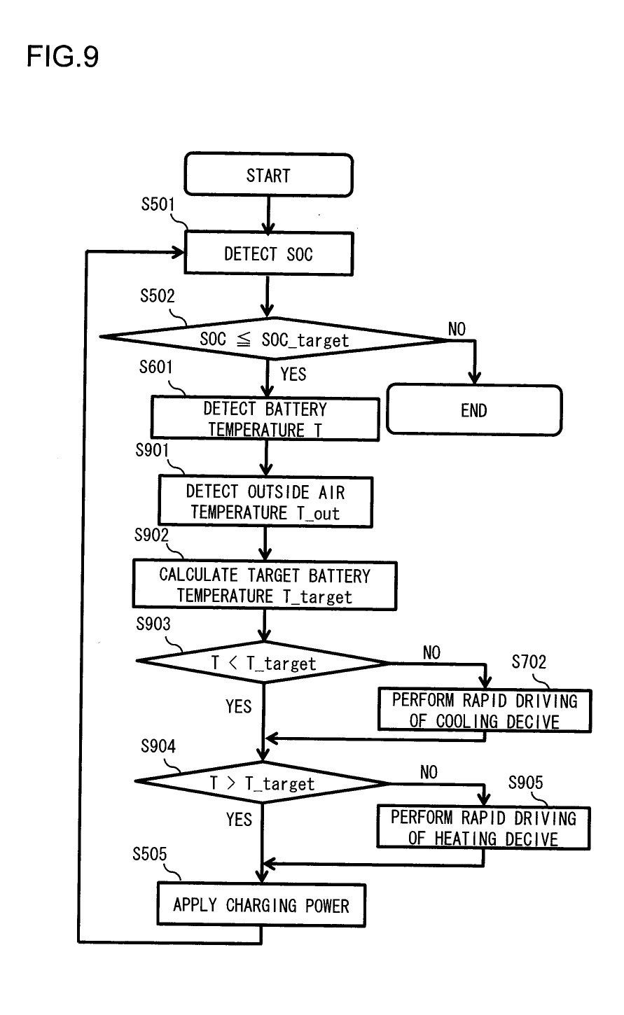

FIG. 9 presents a flowchart illustrating processing in a second charging mode performed in the charge control system according to the second embodiment instead of the processing illustrated by the flowchart in FIG. 7. In the flowchart in FIG. 9, like FIG. 7, the processing steps having the same contents as those shown in FIGS. 5 and 6 are assigned the same step numbers as those used in FIGS. 5 and 6. Further, processing steps in FIG. 9 having the same contents as those in shown in FIG. 7 are assigned the same step numbers as those used in FIG. 7.

In each of steps S501, S502 and S601, the processing that is the same as that illustrated in FIGS. 5 and 7 is performed by the battery control device 203, the integrated control device 201, and the battery temperature control device 204. That is, the SOC of the battery 105 is detected by the battery control device 203, and the detected SOC is compared with the above-mentioned SOC_target by the integrated control device 201. When the detected SOC is equal to or lower than SOC_target, the battery temperature T is detected by the battery temperature control device 204. On the other hand, when the detected SOC is higher than SOC_target, the operation in the second charging mode shown in FIG. 9 is ended to complete charging of the battery 105.

In step S901, the outside air temperature T_out is detected by the battery temperature control device 204. Here, the outside air temperature T_out is detected by using the outside air temperature sensor 111 shown in FIG. 1. On this occasion, a command to detect the outside air temperature T_out is output from the integrated control device 201 to the battery temperature control device 204. In response to this command, the battery temperature control device 204 detects the outside air temperature T_out by using the outside air temperature sensor 111. The detected outside air temperature T_out is output from the battery temperature control device 204 to the integrated control device 201.

In step S902, the target battery temperature T_target is calculated by the integrated control device 201 based on the outside air temperature T_out detected in step S901. Here, an offset temperature delta_T is determined based on the outside air temperature T_out in a manner explained later, and the resultant offset temperature delta_T is added to the lower limit value T_min of the charge-discharge allowing battery temperature to calculate the target battery temperature T_target. The calculated target battery temperature T_target is output from the integrated control device 201 to the battery temperature control device 204.

In step S903, the battery temperature T detected in step S601 is compared with the target battery temperature T_target calculated in step S902 by the battery temperature control device 204. As a result, when the battery temperature T is lower than T_target, the process proceeds to step S904. On the other hand, when the battery temperature T is equal to or greater than T_target, the process proceeds to step S702.

In step S702, the cooling device 106 is driven by the battery temperature control device 204 similarly to the process explained in FIG. 7 to perform rapid cooling control. With this, the cooling device 106 is controlled such that the battery temperature T rapidly approaches to the target battery temperature T_target. In step S702, after performing the rapid cooling control, the process proceeds to step S904.

In step S904, the battery temperature T detected in step S601 is compared with the target battery temperature T_target by the battery temperature control device 204 calculated in step S902. As a result, when the battery temperature T is higher than T_target, the process proceeds to step S505. On the other hand, when the battery temperature T is equal to or lower than T_target, the process proceeds to step S905.

In step S905, the heating device 107 is driven by the battery temperature control device 204 to perform rapid heating control. On this occasion, the battery temperature control device 204 controls the heating device 107 to increase an output therefrom to a level higher than that of the output in normal heating, so that the heating device 107 can exhibit a heating capacity higher than that upon normal heating in step S603 illustrated in FIG. 6. For example, when the heating capacity of the heating device 107 can be varied depending on the power consumed by the heating device 107, the heating device 107 is operated such that its power consumption is larger than that upon normal heating. In this manner, the heating device 107 is controlled so that the battery temperature T rapidly approaches to the target battery temperature T_target. After the rapid heating control is performed in step S905, the process proceeds to step S505.

In step S505, charging power is applied to the battery 105 by the charger 108. Here, similarly to the case illustrated in FIG. 7, a command to perform charging in a constant voltage mode is output from the integrated control device 201 to the charger control device 206. In response to this command, the charger control device 206 controls the charger 108 to charge the battery 105.

After the process in step S505 is performed, the process returns to step S501 and the SOC of the battery 105 is detected again by the battery control device 203. By performing the above-mentioned processes, the battery 105 is rapidly cooled or rapidly heated by the cooling device 106 or the heating device 107, respectively, so that the battery temperature T becomes T-target until SOC>SOC_target is satisfied to charge the battery 105 in the second charging mode.

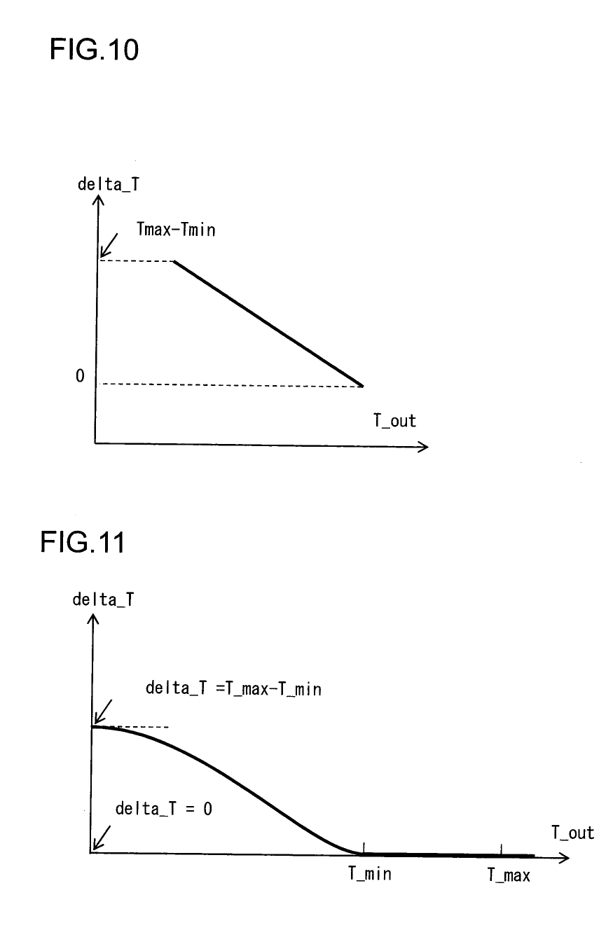

Here, the method of determining the offset temperature delta_T based on the outside air temperature T_out in step S902 is described. FIG. 10 presents a graph showing an example of the relationship between the outside air temperature T_out and the offset temperature delta_T. In FIG. 10, the horizontal axis represents an outside air temperature T_out and the vertical axis represents an offset temperature delta_T.

As shown in FIG. 10, a set value of the offset temperature delta_T is stored in advance in the battery temperature control device 204. The set value is defined such that it decreases as the outside air temperature T_out increases, its maximum value (upper limit value) is a value obtained by subtracting the lower limit value T_min from the upper limit value T_max of the charge-discharge allowing battery temperature (T_max−T_min), and its minimum value (lower limit value) is 0. Based on this set value, the offset temperature delta_T that depends on the outside air temperature T_out detected in step S902 is determined. That is, the offset temperature delta_T is determined such that it is between the maximum value of T_max−T_min and the minimum value of 0.

Alternatively, the offset temperature delta_T that depends on the outside air temperature T_out may be determined based on the relationship between the outside air temperature T_out and the offset temperature delta_T as shown in FIG. 11. In the example shown in FIG. 11, the offset temperature delta_T is such that the offset temperature delta_T is 0 when the outside air temperature T_out is not lower than the lower limit value T_min of the charge-discharge allowing battery temperature. The offset temperature delta_T that depends on the detected outside air temperature T_out can be determined by using various relationships between the outside temperature T_out and the offset temperature delta_T as well as the respective examples shown in FIGS. 10 and 11 as explained above.

In the relationships between the outside air temperature T_out and the offset temperature delta_T shown in FIGS. 10 and 11, the lower limit value T_min and the upper limit value T_max of the charge-discharge allowing battery temperature are preferably determined based on the characteristics of the battery 105 similarly to the case explained in the first embodiment mentioned above. That is, the lower limit value T_min and the upper limit value T_max of the charge-discharge allowing battery temperature may be set in advance taking into consideration the deterioration of the battery 105 and other factors.

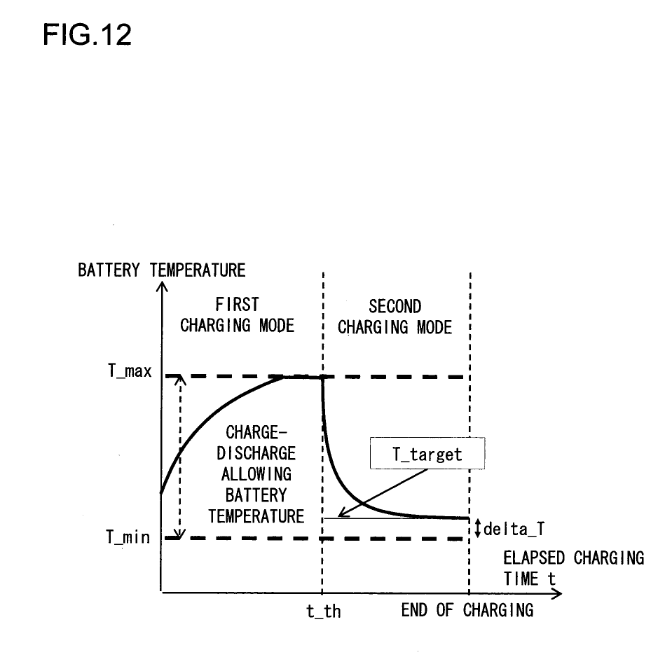

An example of the variation of battery temperature when the battery 105 is charged based on the control flowchart shown in FIG. 9 explained above by using the charge control system is shown in the graph in FIG. 12.

As shown in FIG. 12, the battery temperature T in the first charging mode increases similarly to the example shown in the upper diagram in FIG. 8. On the other hand, in the second charging mode, the battery temperature T rapidly decreases to the target battery temperature T_target, which is higher by the offset temperature delta_T than the lower limit value T_min of the charge-discharge allowing battery temperature. During this period, by the rapid cooling control or rapid heating control performed by the battery temperature control device 204, the cooling device 106 or the heating device 107 is controlled such that T=T_target can be attained. As a result, the battery 105 is positively cooled or heated.

According to the second embodiment as explained above, the advantageous effects as indicated in (3) to (7) below as well as the one indicated in (1) according to the first embodiment as mentioned above can be obtained.

(3) In the second charging mode, the outside air temperature T_out is detected by the battery temperature control device 204 (step S901 in FIG. 9), and the target battery temperature T_target is calculated by the integrated control device 201 based on the detected outside air temperature T_out (step S902 in FIG. 9). And the calculated target battery temperature T_target is compared with the battery temperature T (steps S903 and S904 in FIG. 9), and based on the result of comparison, rapid cooling control using the cooling device 106 and rapid heating control using the heating device 107 are performed (steps S702 and S905 in FIG. 9). By so doing, the battery temperature T immediately after completion of charging can be appropriately controlled depending on the outside air temperature T_out.

(4) In step S902, the integrated control device 201 determines the offset temperature delta_T based on the outside air temperature T_out and calculates the target battery temperature T_target by adding the determined offset temperature delta_T to the lower limit value T_min of the charge-discharge allowing battery temperature. With this, the target battery temperature T_target that is most suitable for the outside air temperature T_out can be easily and certainly calculated.

(5) In step S902, the integrated control device 201 is configured to determine the offset temperature delta_T between its maximum value and minimum value. On this occasion, a value (T_max−T_min) obtained by subtracting the lower limit value T_min of the charge-discharge allowing battery temperature from a predetermined upper limit value T_max of the charge-discharge allowing battery temperature is defined to be a maximum value of the offset temperature delta_T and 0 is defined to be a minimum value of the offset temperature delta_T. With this, the offset temperature delta_T can be determined within a suitable range.

(6) The upper limit value T_max and the lower limit value T_min of the charge-discharge allowing battery temperature can be determined in advance taking into consideration the deterioration of the battery 105. The integrated control device 201 can determine the most suitable offset temperature delta_T when the battery 105 is charged by performing the processing in step S902 using these values.

(7) In step S902, the integrated control device 201 sets a lower offset temperature delta_T when the outside air temperature T_out is higher based on the relationship between the outside air temperature T_out and the offset temperature delta_T shown in FIGS. 10 and 11. With this, the higher the outside air temperature T_out is, the smaller is the value of target battery temperature T_target that can be obtained as a result of calculation. Since the battery temperature T is controlled based on the target battery temperature T_target thus obtained, the cooling device 106 or the heating device 107 can be used as little as possible even when the battery temperature T varies upon running of the electric vehicle 101 after completion of charging. That is, when the outside air temperature T_out is low, it is considered that the battery temperature T does not increase so much even if the electric vehicle 101 is run immediately after completion of charging. Therefore, the target battery temperature T_target is set high to prevent excess cooling from occurring. On the other hand, when the outside air temperature T_out is high, the target battery temperature T_target is set at a low level, so that the power consumption of the battery 105 due to the cooling device 106 being driven during running of the electric vehicle 101 can be effectively reduced. As a result, the cruising distance of the electric vehicle 101 can be further increased.

### Third Embodiment

Next, the charge control system according to a third embodiment of the present invention is explained below. The present embodiment is different from the second embodiment as explained above in that in step S902 in FIG. 9, the offset temperature delta_T is determined based on a forecasted load of the battery 105 and the outside air temperature T_target and the target battery temperature T_target is calculated.

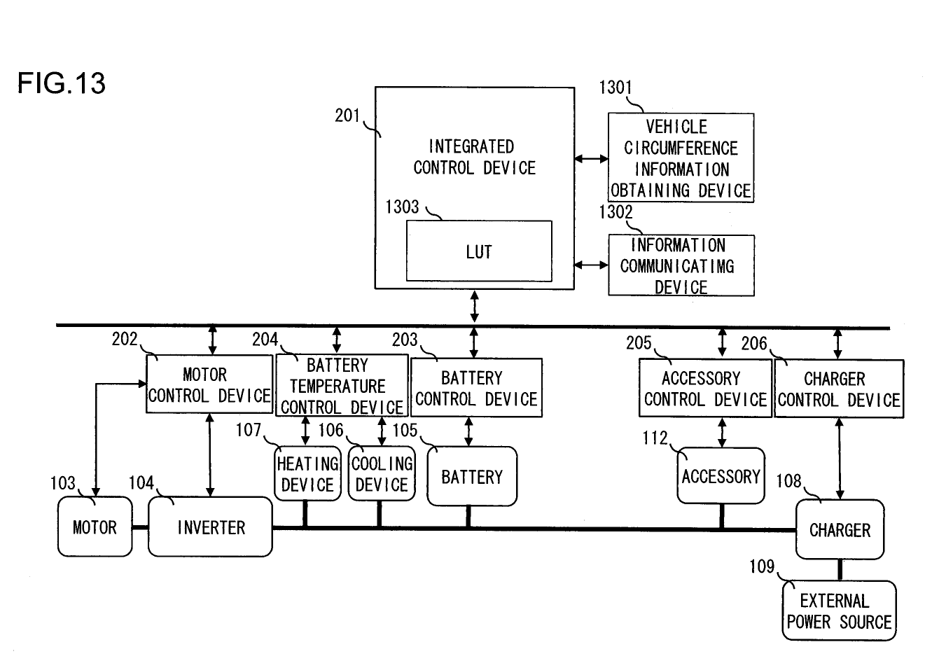

FIG. 13 presents a construction diagram that shows the charge control system according to the third embodiment of the present invention. Compared with the charge control system shown in FIG. 2, the charge control system of the present embodiment includes a vehicle circumference information obtaining device 1301, an information communicating device 1302 and, in the integrated control device 201, LUT (Look Up Table) 1303 that indicates relationships among the forecasted load of the battery 105, the outside air temperature T_out, and the offset temperature delta_T.

The vehicle circumference information obtaining device 1301 is a device that obtains information on road conditions circumjacent the electric vehicle 101 as vehicle circumference information. For example, the vehicle circumference information obtaining device 1301 obtains the present position of the electric vehicle 101 and information on traffic jam and information on a difference in height and so on therearound as vehicle circumference information. The vehicle circumference information obtaining device 1301 can be realized by a navigation device, for example.

The information communicating device 1302 is a device that receives information necessary for obtaining forecasted load of the battery 105 from outside. For example, the information communicating device 1302 receives from the external power source 109 connected to the charger 108 information relating to its installation location.

The integrated control device 201 estimates a forecasted load of the battery 105 in step S902 in FIG. 9 based on the vehicle circumference information obtained by the vehicle circumference information obtaining device 1301 and the information received by the information communicating device 1302. Here, the size of the forecasted load of the battery 105 can be estimated, for example, as follows.

(a) In case a forecasted load is to be obtained from the traffic jam information:

When the present position of the electric vehicle 101 and traffic jam information of roads in the vicinity thereof are obtained as the vehicle circumference information by the vehicle circumference information obtaining device 1301, the magnitude of the forecasted load can be estimated from the traffic jam information. For example, whether or not the road on which the electric vehicle 101 will run is jammed is determined based on the traffic jam information. As a result, if the traffic on the road is slow, it is predicted that the electric vehicle 101 runs thereon at reduced speed, so that the forecasted load of the battery 105 will be low. On the contrary, if the traffic on the road is not jammed, it is presumed that the forecasted load of the battery 105 will be high.

(b) In case a forecasted load is to be obtained from difference-in-height information:

When the present position of the electric vehicle 101 and difference-in-height information of roads in the vicinity thereof are obtained as the vehicle circumference information by the vehicle circumference information obtaining device 1301, the magnitude of the forecasted load can be estimated from the difference-in-height information. For example, the difference-in-height of the road on which the electric vehicle 101 will run is calculated based on the difference-in-height information. As a result, if the difference in height is smaller than a predetermined value, it is presumed that the forecasted load of the battery 105 is low, or if the difference in height is not smaller than the predetermined value, it is presumed that the forecasted load of the battery 105 is high.

(c) In case a forecasted load is obtained from the installation location of the external power source 109:

When information on the installation location of the external power source 109 is received by the information communicating device 1302, the forecasted load can be estimated from this information. For example, when the installation location of the external power source 109 obtained from the received information is home or a charging facility along an ordinary road, the forecasted load of the battery 105 is estimated to be low. On the other hand, when the installation location of the external power source 109 is a service area or a parking area of a highway, the forecasted load of the battery 105 is estimated to be high.

The estimation methods (a), (b), and (c) mentioned above are by way of examples and various other methods may be used to estimate forecasted load of the battery 105. Forecasted loads of the battery 105 may be estimated by using a plurality of kinds of methods. Further, in each of the above-mentioned examples, it is estimated which one of “high” or “low” load the forecasted load corresponds to. However, estimation may be made by using three or more forecasted loads and determining which one of them does correspond to. Alternatively, degrees of estimated loads may be expressed in numerical values.

After the forecasted load of the battery 105 is estimated by one of the above-mentioned method, the integrated control device 201 determines the offset temperature delta_T based on the estimated forecasted load and the outside air temperature T_out detected in step S901. Here, the offset temperature delta_T that corresponds to the level of the estimated forecasted load and the outside air temperature T_out is retrieved from LUT 1303 and the offset temperature delta_T is determined based on the result of retrieval.

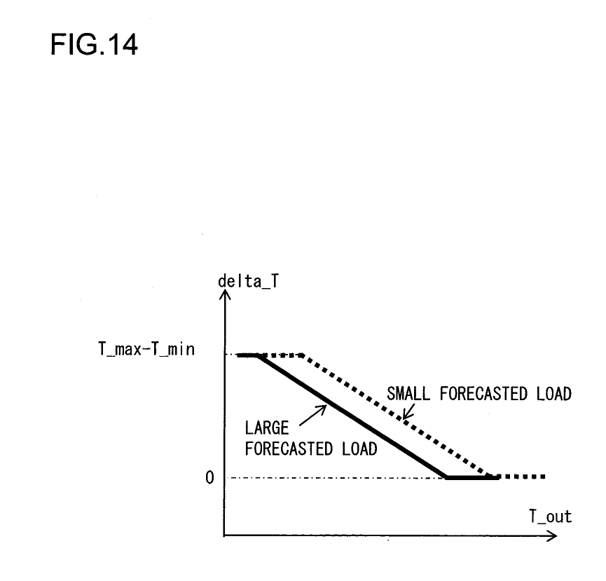

FIG. 14 presents a graph that shows an example of the relationship among the outside air temperature T_out, forecasted load, and offset temperature delta_T. In FIG. 14, the horizontal axis represents the outside air temperature T_out and the vertical axis represents the offset temperature delta_T. The graph shown in broken line represents the relationship between the outside air temperature T_out and the offset temperature delta_T when the forecasted load is low, and the graph shown in solid line represents the relationship between the outside air temperature T_out and the offset temperature delta_T when the forecasted load is high. These relationships are stored in advance in the integrated control device 201 as LUT 1303, which is used to determine the offset temperature delta_T.

According to the third embodiment explained above, there can be obtained advantageous effects (8) and (9) below as well as the advantageous effect (1) of the first embodiment and the advantageous effects (3), (5), and (6) of the second embodiment.

(8) In step S902, the integrated control device 201 estimates the forecasted load of the battery 105, determines the offset temperature delta_T based on the estimated forecasted load and the outside air temperature T_out, and adds the offset temperature delta_T to the lower limit value T_min of the charge-discharge allowing battery temperature to calculate the target battery temperature T_target. With this, the most suitable target battery temperature T_target that depends on the forecasted load of the battery 105 and the outside temperature T_out can be easily and certainly calculated.

(9) In step S902, the integrated control device 201 sets the offset temperature delta_T based on the relationship among the outside air temperature T_out, forecasted load, and offset temperature delta_T as shown in FIG. 14 such that the higher the outside air temperature T_out is or the higher the forecasted load is, the lower the offset temperature delta_T is. With this, the higher the outside temperature T_out is or the higher the forecasted load is, the lower value of the target battery temperature T_target can be obtained as a result of calculation. The battery temperature T is controlled based on the target battery temperature T_target thus obtained, so that even when the electric vehicle 101 runs after completion of charging and the battery temperature T varies depending on the outside air temperature and the load of the battery 105 at that time, the cooling device 106 or the heating device 107 can be used as little as possible. That is, when the outside air temperature T_out is low and the load of the battery 105 is low, a decrease in the battery temperature T tends to occur even when the electric vehicle 101 is run immediately after completion of charging. In this case, by increasing the target battery temperature T_target, the power consumption of the battery 105 due to the heating device 107 being driven during running of the electric vehicle 101 can be effectively prevented. Therefore, the cruising distance of the electric vehicle 101 can be further increased.

### Fourth Embodiment

Next, the charge control system according to a fourth embodiment of the present invention is explained. The present embodiment is different from the third embodiment mentioned above in that in step S902 in FIG. 9, a battery temperature variation, which is a variation in battery temperature, is obtained based on the forecasted load of the battery 105 and the outside air temperature T_out, and the offset temperature delta_T is determined based on the obtained battery temperature variation. The battery temperature variation referred to herein means inclination of a change in battery temperature when the battery 105 is given a load under the condition of a given outside air temperature T_out.

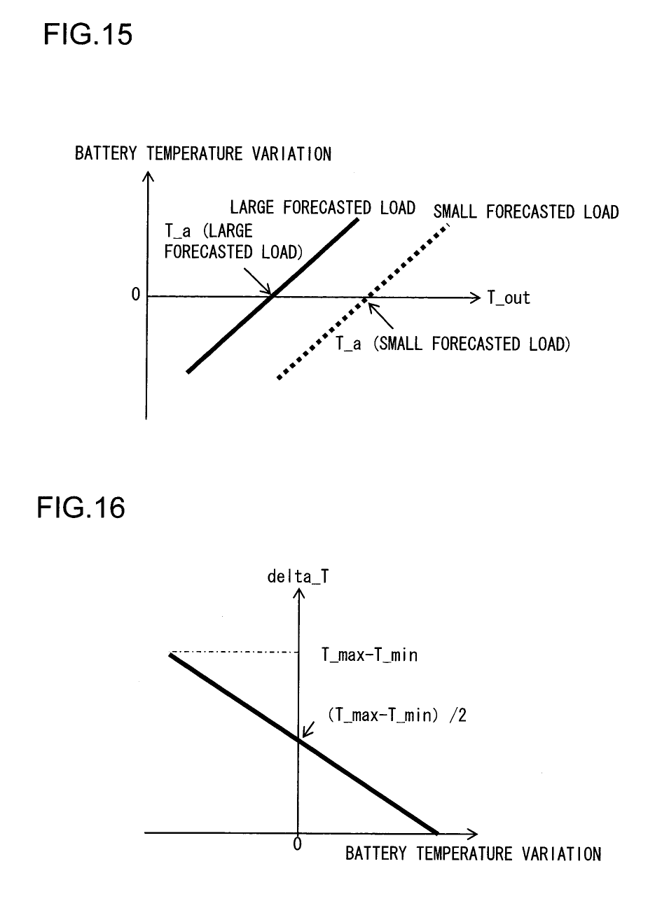

FIG. 15 presents a graph showing an example of the relationship among the outside air temperature T_out, the forecasted load, and the battery temperature variation. In FIG. 15, the horizontal axis represents outside air temperature T_out, and the vertical axis represents the battery temperature variation. The graph shown in broken line indicates the relationship between the outside air temperature T_out and the battery temperature variation when the forecasted load is low. The graph in solid line indicates the relationship between the outside air temperature T_out and the battery temperature variation when the forecasted load is high. FIG. 15 shows that at the same outside air temperature T_out, the higher the forecasted load is, the larger the battery temperature variation is. These relationships are stored in advance in the integrated control device 201 as LUT 1303, which can be used to determine the offset temperature delta_T.

After the battery temperature variation is obtained based on the above-mentioned relationship among the outside air temperature T_out, the forecasted load, and the battery temperature variation, then the integrated control device 201 determines offset temperature delta_T based on the obtained battery temperature variation. Here, the offset temperature delta_T corresponding to the magnitude of the obtained battery temperature variation is searched from LUT 1303 and the offset temperature delta_T is determined based on the result of search.

FIG. 16 presents a graph showing an example of the relationship between the battery temperature variation and the offset temperature. In FIG. 16, the horizontal axis represents battery temperature variation and the vertical axis represents offset temperature delta_T. FIG. 16 indicates that the offset temperature delta_T decreases as the battery temperature variation increases and when the battery temperature variation is 0, delta_T=(T_max−T_min)/2. These relationships are stored in advance in the integrated control device 201 as LUT 1303, which is used to determine the offset temperature delta_T.

According to the fourth embodiment explained above, there can be obtained advantageous effects as in (10) to (12) below as well as the advantageous effect (1) of the first embodiment and the advantageous effects (3) and (6) of the second embodiment.

(10) In step S902, the integrated control device 201 estimates a forecasted load of the battery 105, obtains a battery temperature variation based on the estimated forecasted load and the outside air temperature T_out, determines an offset temperature delta_T based on the obtained battery temperature variation, and adds the offset temperature delta_T to the lower limit value T_min of the charge-discharge allowing battery temperature to calculate a target battery temperature T_target. With this, the most suitable target battery temperature T_target appropriate for the forecasted load of the battery 105 and the outside air temperature T_out can be easily and certainly calculated taking into consideration the inclination of a change in battery temperature when a load is given to the battery 105 under the condition of the outside air temperature T_out.

(11) The integrated control device 201 is configured to determine an offset temperature delta_T in step S902 by taking a value (T_max−T_min)/2, which is an intermediate value between the upper limit value T_max and the lower limit value T_min of charge-discharge allowing battery temperature as an offset temperature delta_T when the battery temperature variation is 0 and adjusting the offset temperature delta_T such that when the battery temperature variation assumes a positive value, the offset temperature delta_T is smaller than (T_max−T_min)/2 and when the battery temperature variation assumes a negative value, the offset temperature delta_T is larger than (T_max−T_min)/2. With this, the offset temperature delta_T can be determined such that it is in a suitable range.

(12) In step S902, the integrated control device 201 controls the battery temperature variation to be larger for a higher outside air temperature T_out or a higher forecasted load based on the relationship among the outside air temperature T_out, the forecasted load, and the battery temperature variation shown in FIG. 15. With this, the higher the outside air temperature T_out is or the higher the forecasted load is, the larger is the battery temperature variation obtained as the result of calculation. The target battery temperature T_target is calculated based on the battery temperature variation thus obtained to control the battery temperature T, so that the cooling device 106 or the heating device 107 may be used as little as possible even when the electric vehicle 101 runs after completion of charging and the battery temperature T varies depending on the outside air temperature or the load of the battery 105 at that time similarly to the case explained in the third embodiment. Therefore, the cruising distance of the electric vehicle 101 can be further increased.

### Fifth Embodiment

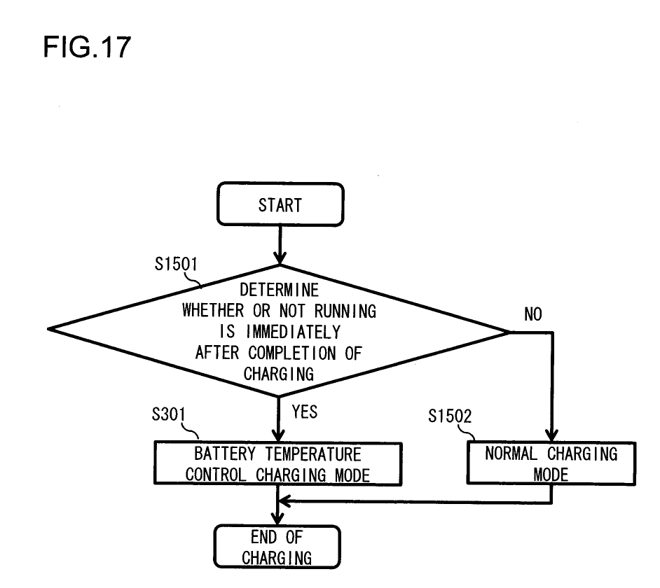

Next, the charge control system according to a fifth embodiment of the present invention is explained. The present embodiment is different from the first to the fourth embodiments in that the control flowchart illustrated in FIG. 17 instead of the control flowchart illustrated in FIG. 3 is performed in the integrated control device 201.

When the electric vehicle 101 is connected to the external power source 109, the processing according to the control flowchart illustrated in FIG. 17 is performed in the integrated control device 201. In step S1501, the integrated control device 201 determines whether or not the electric vehicle 101 starts running immediately after completion of charging. If the running is started immediately after completion of charging, the process proceeds to step S301. On the other hand, if the running is not started immediately after completion of charging, the process proceeds to step S1502.

The determination in step S1501 may be performed depending on the result of operation of the charge control system of the present embodiment by the operator. That is, the integrated control device 201 obtains instruction information from the operator and based on this information, it determines whether or not the operator has instructed the electric vehicle 101 to run immediately after completion of charging.

As explained in the third and the fourth embodiments mentioned above, the determination in step S1501 may be performed based on information from the vehicle circumference information obtaining device 1301 and the information communicating device 1302 in case the charge control system according to the present embodiment includes these devices. For example, the position information of the electric vehicle 101 when charging is started is obtained as vehicle circumference information by the vehicle circumference information obtaining device 1301, and based on the vehicle circumference information thus obtained it is determined whether or not the electric vehicle 101 is in a service area or a parking area on the highway when charging is started. As a result, when the electric vehicle 101 is determined to be in a service area or a parking area on the highway, the result of the determination in step S1501 is YES, whereas when the electric vehicle 101 is determined to be in a location other than these, the result of the determination in step S1501 is NO.

Alternatively, information relative to the installation location of the external power source 109 is received by the information communicating device 1302 and based on this information, it is determined whether or not the external power source 109 is installed in the service area or parking area of the highway. As a result, when the external power source 109 is installed in the service area or parking area on the highway, the result of the determination in step S1501 is YES. On the other hand, when the external power source 190 is installed in a location other than these, the result of the determination in step S1501 is NO.

The position of the electric vehicle 101 or installation location of the external power source 109, which is a subject of determination, is not limited to service areas or parking areas on highways and positions and locations where it is highly possible for the electric vehicle 101 to start running immediately after completion of charging may also be used as subjects of determination. For example, the determination in step S1501 may be performed by selecting all charging installations that are located at places other than home.

The determination in step S1501 can be performed by using various methods as well as the examples mentioned above. For example, in case where a route to the destination is set in a navigation device mounted in the electric vehicle 101 and charging is started in the midway of the route, the result of determination in step S1501 can be YES.

When the result of determination in step S1501 is YES, the integrated control device 201 performs in step S301 charging in the battery temperature control charging mode as illustrated in FIG. 4 similarly to the other embodiments. With this, the operations in the first charging mode in step S401 and the second charging mode in step S402 are performed in sequence.

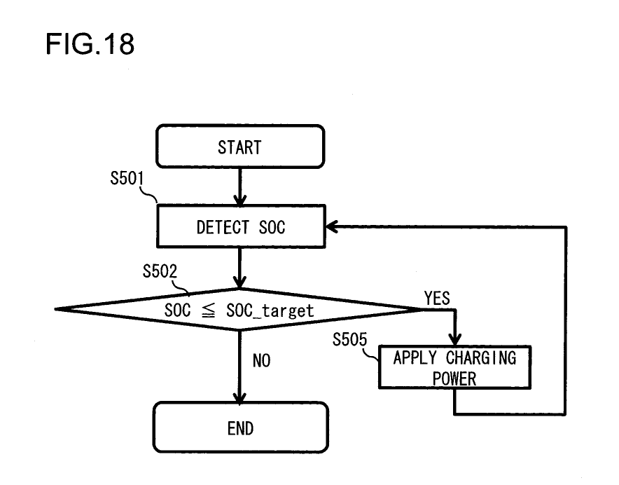

On the other hand, when the result of the determination in step S1501 is NO, the integrated control device 201 performs charging in a normal charging mode in step S1502. Here, the processing illustrated in the flowchart shown in FIG. 18 is performed.

In steps S501 and S502, processing similar to that explained with reference to FIGS. 5, 7 and 9 is performed by the battery control device 203 and the integrated control device 201, respectively. That is, the SOC of the battery 105 is detected by the battery control device 203 and the detected SOC is compared with SOC_target by the integrated control device 201. As a result, the process proceeds to step S505 when SOC is not larger than SOC_target, whereas when SOC is larger than SOC_target, the normal charging mode illustrated in FIG. 18 is ended to complete the charging of the battery 105.

In step S505, charging power is applied to the battery 105 from the charger 108. Here, a command to perform charging is output from the integrated control device 201 to the charger control device 206. On this occasion, it is preferred that charging is performed in a constant current mode if SOC<SOC_th, whereas charging in a constant voltage mode is performed if SOC≧SOC_th. That is, if SOC is less than SOC_th, the charger 108 is controlled such that the charge current that flows in the battery 105 becomes a maximum charge current I_max to charge the battery 105. On the other hand, if SOC is not smaller than SOC_th, the charger 108 is controlled such that the charge voltage applied to the battery 105 becomes a predetermined charge voltage V to charge the battery 105.

After the processing in step S505 is performed, the process returns to step S501, where detection of the SOC of the battery 105 is performed again. By performing the above-mentioned processing, charging of the battery 105 in the normal charging mode is performed until the condition of SOC>SOC_target is satisfied.

According to the fifth embodiment explained above, there can be obtained advantageous effects as those described in (13) and (14) below as well as the advantageous effects described in (1) to (12) above by the respective embodiments.

(13) The integrated control device 201 determines whether or not the electric vehicle 101 starts running immediately after completion of charging (step S1501 in FIG. 17). When it is determined that the running is started immediately after completion of charging, the charging in the battery temperature control charging mode illustrated in FIG. 4 is performed in step S301. On this occasion, the cooling device 106 and the heating device 107 are controlled by the battery temperature control device 204 while the battery 105 is being charged to cool or heat the battery 105, respectively. On the other hand, when it is determined that the running is not started immediately after completion of charging, the charging in the normal charging mode illustrated in FIG. 18 is performed in step S1502. On this occasion, the battery temperature control device 204 is not operated. Neither cooling of the battery 105 by the cooling device 106 nor heating of the battery 105 by the heating device 107 is performed while the battery 105 is being charged. In this manner, the charge control system according to the present embodiment is configured such that when the electric vehicle 101 is not run immediately after charging, the temperature control of the battery 105 is not performed, so that ineffective power consumption in cooling or heating can be avoided.

(14) The integrated control device 201 can obtain at least one of instruction information from the operator, information on position of the electric vehicle 101 from the vehicle circumference information obtaining device 1301, and information relative to installation location of the external power source 109 from the information communicating device 1302. Based on the information thus obtained, the integrated control device 201 can determine whether or not the electric vehicle 101 starts running immediately after completion of charging of the battery 105 in step S1501. By so doing, whether or not the electric vehicle 101 starts running immediately after completion of charging can be certainly determined.

In the above-explained embodiments, the charge control system may be configured such that only one of the cooling device 106 or the heating device 107 is used to perform either a combination of cooling control with rapid cooling control or a combination of heating control with rapid heating control, respectively. In such a case too, the battery temperature control device 204 may be configured to control the cooling device 106 or the heating device 107 such that the cooling capacity of the cooling device 106 or the heating capacity of the heating device 107 in the second charging mode is higher than the cooling capacity of the cooling device 106 or the heating capacity of the heating device 107 in the first charging mode similarly to the above-mentioned embodiments.

The above-mentioned explanations are by way of examples and the present invention is not limited to the constructions of the above-mentioned embodiments.

What is claimed is:

1. A charge control system for use in an electric vehicle that is mounted thereon for controlling charging of an in-vehicle battery by an external power source, the system comprising:
an SOC detection unit that detects an SOC of the in-vehicle battery;
a battery temperature detection unit that detects a battery temperature of the in-vehicle battery;
a battery temperature control unit that controls a cooling device that cools the in-vehicle battery with a predetermined cooling capacity and a heating device that heats the in-vehicle battery with a predetermined heating capacity based on the battery temperature detected by the battery temperature detection unit;
a charge control unit that controls a charge current and a charge voltage upon charging the in-vehicle battery by the external power source; wherein
the charge control unit switches between a first charging mode in which the charge current is controlled so as to reach a constant value and a second charging mode in which the charge voltage is controlled so as to reach a constant value based on the SOC detected by the SOC detection unit, and
the battery temperature control unit controls at least one of the cooling device and the heating device such that the cooling capacity and/or the heating capacity in the second charging mode are higher than the cooling capacity and/or the heating capacity in the first charging mode.

2. A charge control system according to claim 1, wherein
in the second charging mode, the battery temperature control unit controls at least one of the cooling device and the heating device such that the battery temperature is identical with a predetermined lower limit value of a charge-discharge allowing battery temperature.

3. A charge control system according to claim 1, further comprising:
an outside air temperature detection unit that detects a temperature of outside air; and
a target battery temperature calculation unit that calculates a target battery temperature based on the temperature of the outside air detected by the outside air temperature detection unit, wherein
the battery temperature control unit controls at least one of the cooling device and the heating device such that in the second charging mode, the battery temperature is identical with the target battery temperature.

4. A charge control system according to claim 3, wherein
the target battery temperature calculation unit calculates the target battery temperature by determining an offset temperature based on the temperature of the outside air, and adding the offset temperature to a predetermined lower limit value of a charge-discharge allowing battery temperature.

5. A charge control system according to claim 4, wherein
the target battery temperature calculation unit determines the offset temperature between a maximum value and a minimum value of the offset temperature, taking a value obtained by subtracting the lower limit value of the charge-discharge allowing battery temperature from a predetermined upper limit value of the charge-discharge allowing battery temperature as the maximum value of the offset temperature and taking 0 as the minimum value of the offset temperature.

6. A charge control system according to claim 5, wherein
the upper limit value and the lower limit value of the charge-discharge allowing battery temperature are determined in advance taking into consideration deterioration of the in-vehicle battery.

7. A charge control system according to claim 4, wherein
the target battery temperature calculation unit decreases the offset temperature as the outside air temperature increases.

8. A charge control system according to claim 3, further comprising:
a forecasted load estimation unit that estimates a forecasted load of the in-vehicle battery; wherein
the target battery temperature calculation unit calculates the target battery temperature by determining an offset temperature based on the forecasted load and the outside air temperature, and adding the calculated offset temperature to a predetermined lower limit value of a charge-discharge allowing battery temperature.

9. A charge control system according to claim 8, wherein
the target battery temperature calculation unit determines the offset temperature between a maximum value and a minimum value of the offset temperature, taking a value obtained by subtracting the lower limit value of the charge-discharge allowing battery temperature from a predetermined upper limit value of the charge-discharge allowing battery temperature as the maximum value of the offset temperature and taking 0 as the minimum value of the offset temperature.

10. A charge control system according to claim 9, wherein
the upper limit value and the lower limit value of the charge-discharge allowing battery temperature are determined taking into consideration deterioration of the in-vehicle battery.

11. A charge control system according to claim 8, wherein
the target battery temperature calculation unit decreases the offset temperature as the outside air temperature increases or the forecasted load increases.

12. A charge control system according to claim 3, further comprising:
a forecasted load estimation unit that estimates a forecasted load of the in-vehicle battery, wherein
the target battery temperature calculation unit calculates the target battery temperature by obtaining a battery temperature variation based on the forecasted load and the outside air temperature, determining an offset temperature based on the obtained battery temperature variation, and adding the obtained offset temperature to a predetermined lower limit value of a charge-discharge allowing temperature.

13. A charge control system according to claim 12, wherein
the target battery temperature calculation unit determines the offset temperature by assuming an intermediate value between a predetermined upper limit value of the charge-discharge allowing battery temperature and the lower limit value of the charge-discharge allowing battery temperature to be the offset temperature when the battery temperature variation is 0 and adjusting the offset temperature so as to become smaller than the intermediate value when the battery temperature variation takes a negative value and larger than the intermediate temperature when the battery temperature variation takes a negative value.

14. A charge control system according to claim 13, wherein
the upper limit value and the lower limit value of the charge-discharge allowing battery temperature are determined in advance taking into consideration deterioration of the in-vehicle battery.

15. A charge control system according to claim 12, wherein
the target battery temperature calculation unit increases the battery temperature variation as the outside air temperature increases or the forecasted load increases.

16. A charge control system according to claim 1, further comprising:
an immediately-after-completion-of-charging running determination unit that determines whether or not the electric vehicle starts running immediately after completion of charging the in-vehicle battery, wherein
the battery temperature control unit controls the cooling device and/or the heating device to cool and/or heat the in-vehicle battery while the in-vehicle is being charged when it is determined by the immediately-after-completion-of-charging running determination unit that the electric vehicle starts running immediately after completion of charging of the in-vehicle battery,
whereas the battery temperature control unit controls the cooling device and the heating device not to cool and heat, respectively, the in-vehicle battery while the in-vehicle battery is being charged when it is determined by the immediately-after-completion-of-charging running determination unit that the electric vehicle does not start running immediately after completion of charging of the in-vehicle battery.

17. A charge control system according to claim 16, further comprising:
an information obtaining unit that obtains at least one of instruction information from an operator, position information on the position of the electric vehicle, and information on an installation location of the external power source, wherein
the immediately-after-completion-of-charging running determination unit determines whether or not the electric vehicle starts running immediately after completion of charging the in-vehicle battery based on the information obtained by the information obtaining unit.
